(19) United States
(12) Patent Application Publication
(10) Pub. No.: US 2011/0067072 A1
(43) Pub. Date: Mar. 17, 2011

(54) Method and apparatus for performing MPEG video streaming over bandwidth constrained networks

(76) Inventors: Shyam Parekh, Orinda, CA (US); Doru Calin, Manalapan, NJ (US); Ehsan Haghani, Albany, CA (US); Eunyoung Kim, New York, NY (US)

(21) Appl. No.: 12/589,663

(22) Filed: Oct. 27, 2009

Related U.S. Application Data
(60) Provisional application No. 61/276,588, filed on Sep. 14, 2009.

(51) Int. Cl. H04N 7/32; H04N 7/16; G06F 15/16

(52) U.S. Cl. 725/62; 375/240.15; 375/E07.243; 709/231

(57) ABSTRACT

A method and apparatus for preserving the video quality of encoded video signals when transmitted over a communications network. The video signals may comprise Motion Picture Experts Group (MPEG) encoded video signals and the communications network may comprise a WiMAX or an LTE network. Illustratively, an MPEG encoded video signal is decomposed into three component video streams made up of I-frames, P-frames and B-frames, respectively. The three video streams may then be independently transmitted as separate and independent flows with different Quality of Service (QoS) levels. For example, the video stream comprising I-frames may be assigned a highest QoS level, while the video stream comprising B-frames may be assigned a lowest QoS level (with the video stream comprising P-frames assigned a QoS level therebetween). A receiver at the receiving end receives the independently transmitted video streams and combines them together to reproduce the encoded video signal.

### RELATED APPLICATION

The present application claims priority from U.S. Provisional Patent Application Ser. No. 61/276,588, filed on Sep. 14, 2009.

### FIELD OF THE INVENTION

The present invention relates generally to the field of video encoding and transmission of encoded video signals, and more particularly to a method and apparatus for improving the quality of encoded video signals such as those encoded using an MPEG (Moving Picture Experts Group) encoding technique when such encoded video signals are transmitted over a congested network.

### BACKGROUND OF THE INVENTION

The excessive demand for ubiquitous broadband access, particularly in a wireless context, has attracted tremendous investment from the telecommunications industry in the development and deployment of sophisticated communications networks such as, for example, Worldwide Interoperability for Microwave Access (WiMAX) networks and Long Term Evolution (LTE) of Universal Mobile Telecommunications System (UTMS) networks (usually referred to as simply LTE). In particular, it is expected that video streaming will be a very attractive application for the rapid deployment of such networks. For example, the popularity of many online video servers will encourage an increasing number of users to watch video clips on their mobile devices. But the substantial bandwidth requirements associated with video signal transmission often results in a network bottleneck, since the bandwidth available in typical wireless networks is relatively scarce. This fact calls for very efficient resource management techniques.

Advantageously, WiMAX networks in particular are based on the IEEE 802.16 standard which has defined different QoS classes to support a broad range of applications with varying service requirements. (The IEEE 802.16 standard is fully familiar to those of ordinary skill in the art.) Specifically, the IEEE 802.16 standard provides true QoS classes for different types of applications. As a result, in WiMAX networks, each traffic flow may be mapped into an appropriate service class based on its service requirements and the given user's applications' QoS parameters. As such, an encoded video signal, like other traffic flows, is typically transmitted in an assigned service class, which may or may not provide an adequate quality to the user receiving the video.

### SUMMARY OF THE INVENTION

We have recognized that, given the inherent bandwidth limitations of many communications networks such as, for example, wireless networks, and given the capability of today's communications networks such as, for example, WiMAX and LTE networks, to offer differing QoS levels to different traffic flows, it would be highly advantageous if a system could take advantage of such different QoS levels when transmitting a given video signal across the network. In particular, we note that a typical encoded video signal comprises a plurality of individual encoded video frames, and that various ones of these frames are encoded with use of different encoding formats. As such, we have further recognized that by decomposing an encoded video signal into a plurality of separate, independent video streams, and then transmitting these independent video streams as separate flows, each of these separate flows may, for example, be advantageously assigned different QoS levels such that those flows which comprise more “important” portions of the video signal can be transmitted with a higher minimum reserved bandwidth than those flows which comprise less “important” portions.

In particular, in accordance with various illustrative embodiments of the present invention, a method and apparatus for transmitting an encoded video signal across a communications network (such as, for example, a WiMAX or an LTE network) is provided, the encoded video signal comprising a plurality of encoded video frames, each encoded video frame having been encoded in one of two or more different encoding formats, the method and apparatus comprising decomposing the encoded video signal into two or more video streams, each video stream comprising frames which have been encoded in one or more mutually exclusive formats with respect to each of the other video streams; and independently transmitting each of the two or more video streams across the communications network as separate and independent flows.

In addition, in accordance with various other illustrative embodiments of the present invention, a method and apparatus for receiving an encoded video signal from a communications network (such as, for example, a WiMAX or an LTE network) is provided, the encoded video signal comprising a plurality of encoded video frames, each encoded video frame having been encoded in one of two or more different encoding formats, the method and apparatus comprising receiving two or more independently transmitted video streams as separate and independent flows, each video stream comprising frames which have been encoded in one or more mutually exclusive formats with respect to each of the other video streams; and combining the received video frames to reproduce the encoded video signal.

In accordance with certain illustrative embodiments of the present invention, the encoded video signal may have been encoded in accordance with a Motion Picture Experts Group (MPEG) encoding technique, and the encoding formats may include Intra-coded frames (I-frames), forward Predictive frames (P-frames) and Bi-directionally predicted frames (B-frames). In accordance with such an illustrative embodiment of the present invention, the encoded video signal may be advantageously decomposed into three video streams, the three video streams including a first video stream comprising exclusively I-frames, a second video stream comprising exclusively P-frames, and a third video stream comprising exclusively B-frames. In addition, in accordance with certain illustrative embodiments of the present invention, each of the independently transmitted video streams may be transmitted with a different Quality of Service (QoS) level, wherein the QoS of each transmitted video stream is based on a corresponding QoS set of parameters representative of a minimum reserved bandwidth which is to be associated therewith.

### BRIEF DESCRIPTION OF THE DRAWINGS

FIG. 1 shows an example of how a video signal may be advantageously encoded using a Motion Pictures Expert Group (MPEG) encoding technique for use with an illustrative embodiment of the present invention.

FIG. 2 shows an example of how an encoded video signal encoded in accordance with the example MPEG encoding method of FIG. 1 may be advantageously decomposed into a plurality of separate, independent video streams in accordance with an illustrative embodiment of the present invention.

FIG. 3 shows a simplified view of a typical wireless (e.g., WiMAX or LTE) communications network based video streaming environment in which an illustrative embodiment of the present invention may be advantageously employed.

FIG. 4 shows a flowchart of a method of transmitting an encoded video signal across a communications network in accordance with an illustrative embodiment of the present invention.

FIG. 5 shows a block diagram of an apparatus for transmitting an encoded video signal across a communications network in accordance with an illustrative embodiment of the present invention.

FIG. 6 shows a flowchart of a method of receiving an encoded video signal from a communications network in accordance with an illustrative embodiment of the present invention.

FIG. 7 shows a block diagram of an apparatus for receiving an encoded video signal from a communications network in accordance with an illustrative embodiment of the present invention.

### DETAILED DESCRIPTION OF THE PREFERRED EMBODIMENTS

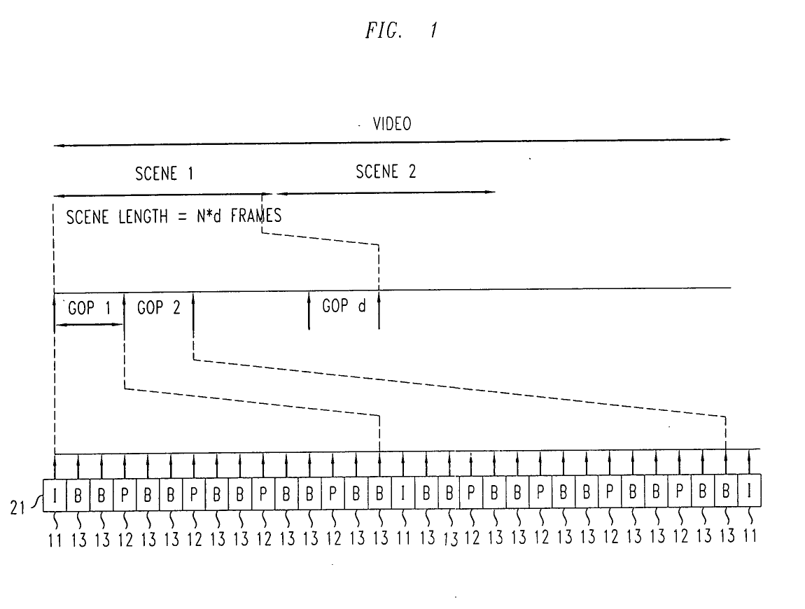

FIG. 1 shows an example of how a video signal may be advantageously encoded using a Motion Pictures Expert Group (MPEG) encoding technique for use with an illustrative embodiment of the present invention. MPEG encoding techniques are conventional and fully familiar to those of ordinary skill in the art. As is well known, a video signal comprises a sequence of frames, each of which comprises a (still) image, such that the sequence of images when displayed in real time produces the resultant video. In conventional video encoding techniques, each of these frames is encoded so as to reduce the quantity of data that must be used to represent it and thus, for example, to reduce the quantity of data which must be transmitted across a communications network.

In MPEG encoded video, there are typically three encoding formats which are advantageously employed to encode the frames of the video signal. These three formats comprise Intra-coded frames (I-frames), which encode the given frame without any reference to any other frames; forward Predictive frames (P-frames), which encode the given frame with reference to (e.g., as a difference from) a previous I-frame or P-frame in the sequence of video frames (which may or may not be the immediately preceding frame); and Bi-directionally predicted frames (B-frames), which encode the given frame with reference to both (e.g., as an interpolation between) an earlier frame in the sequence of video frames and a later frame in the sequence of video frames (which requires information from the surrounding I-frames and/or P-frames).

The particular example of an MPEG encoded video signal shown in FIG. 1 illustrates that a sequence of video “scenes” may be advantageously divided into a sequence of (in this case, “d”) picture groups (“Group of Pictures” or GOP), each of which comprises a sequence of (in this case, “N”) frames. (The value of N may illustratively be 12 or 15, for example.) Then, each frame is advantageously encoded using one of the three encoding formats. Typically, the first frame in such a group of pictures is advantageously encoded as an I-frame, and periodically occurring frames thereafter are advantageously encoded as P-frames (in this case, every third frame). The remaining frames in the group of pictures are advantageously encoded as B-frames. Thus, encoded video signal 21 as shown in the figure comprises I-frames 11, P-frames 12, and B-frames 13. Note that in this typical scenario, the majority of frames of the video signal will be encoded as B-frames, while the number of frames encoded as I-frames is low, relative to the number of frames encoded using the other encoding formats.

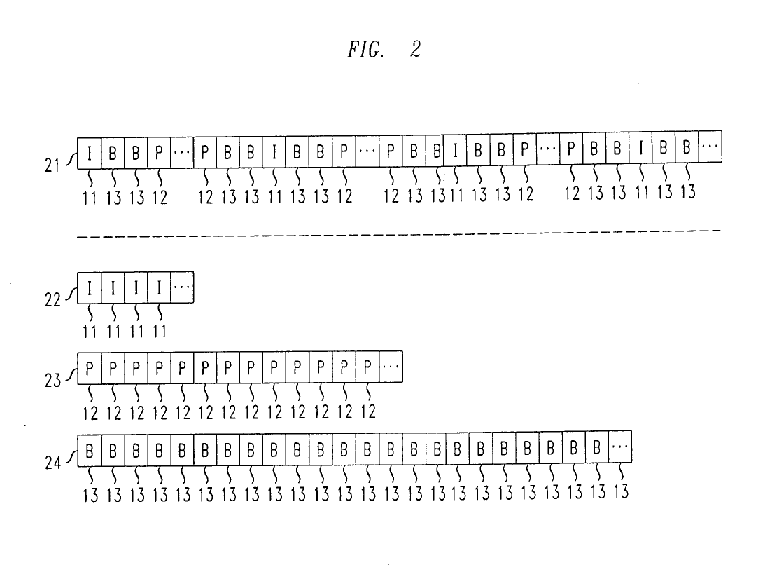

FIG. 2 shows an example of how an encoded video signal encoded in accordance with the example MPEG encoding method of FIG. 1 may be advantageously decomposed into a plurality of separate, independent video streams in accordance with an illustrative embodiment of the present invention. The figure shows encoded video signal 21 which comprises a sequence of encoded video frames, including I-frames 11, P-frames 12, and B-frames 13. In accordance with the principles of the present invention, this encoded video signal is advantageously decomposed into three separate, independent video streams—video stream 22, video stream 23 and video stream 24. (Note that these video streams are independent in the sense that they are capable of being independently transmitted across a communications network, even though the proper interpretation of their content, or “decoding”, may require the referencing of frames in other ones of these video streams. As used herein throughout this specification and in the claims hereof, the term “independent” is to have this meaning.)

Specifically, video stream 22 comprises a sequence of I-frames 11, which consists of all of the I-frames that were included in encoded video signal 21; video stream 23 comprises a sequence of P-frames 12, which consists of all of the P-frames that were included in encoded video signal 21; and video stream 24 comprises a sequence of B-frames 13, which consists of all of the B-frames that were included in encoded video signal 21. Note that for a given portion (e.g., length) of a video signal, there will typically be significantly fewer I-frames 11 in video stream 22 than there will be P-frames 12 in video stream 23, and there will be significantly fewer P-frames 12 in video stream 23 than there will be B-frames 13 in video stream 24.

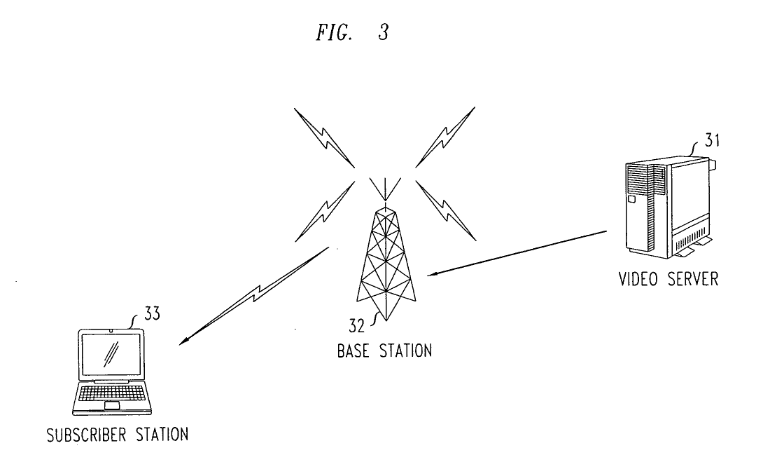

FIG. 3 shows a simplified view of a typical wireless (e.g., WiMAX or LTE) communications network based video streaming environment in which an illustrative embodiment of the present invention may be advantageously employed. The illustrative environment includes video server 31, base station 32 and subscriber station 33. (Of course, in general, such a communications network will comprise multiple video servers, numerous base stations, and a large number of subscriber stations.) In operation, video server 31 transmits a given (i.e., requested) video to base station 32 (generally, but not necessarily, over a wired link), which, in turn, transmits the video wirelessly to subscriber station 33. Whereas in prior art video streaming implementations employing such an illustrative environment, base station 32 would typically transmit a single video signal stream representative of the given video to subscriber station 33, in accordance with the principles of the present invention, base station 32 advantageously transmits a plurality of video signal streams representative of the given video to subscriber station 33, as, for example, is described above in connection with FIG. 2.

In accordance with one illustrative embodiment of the present invention, video server 31 transmits a single video signal stream representative of the given video to base station 32 (as it would in prior art video streaming implementations employing such an illustrative environment). Since the connection between video server 31 and base station 32 is (illustratively) a wired connection, it is reasonably likely that there is sufficient bandwidth available to successfully transmit the video signal at a high quality level. Note, however, that in accordance with an alternative illustrative embodiment of the present invention (e.g., one in which the connection between video server 31 and base station 32 is wireless, or one in which there is limited bandwidth available on this connection for some other reason), video server 31 may itself advantageously transmit a plurality of video signal streams representative of the given video to base station 32 as is described, for example, in connection with FIG. 2. Then, in turn, base station 32 advantageously transmits this plurality of video signal streams representative of the given video to subscriber station 33.

Now consider the scenario within a WiMAX network where multiple MPEG encoded videos are being streamed in the downlink direction from one or more video servers to a number of subscriber stations, and where the sum of the bitrates required by these streams exceeds the total available capacity in the downlink direction, which could be a temporary situation. In accordance with the principles of the present invention and in accordance with an illustrative embodiment thereof, each of the original encoded video signals has been advantageously decomposed into (illustratively) three separate streams (as illustratively shown in FIG. 2), which comprise I-frames, P-frames and B-frames, respectively.

Moreover, in accordance with certain illustrative embodiments of the present invention, each of these component video streams may be advantageously transmitted across the communications network using a different QoS level. In accordance with one such illustrative embodiment of the present invention, each of these component video streams is advantageously transmitted across the communications network using a separate WiMAX real time Polling Service (rtPS) connection. Note that, as used herein, we interchangeably refer to an rtPS connection as an rtPS flow. (As is fully familiar to those of ordinary skill in the art, real time Polling Service is a Quality of Service class which is suitable for supporting video streaming traffic and wherein each traffic flow is characterized by a few parameters such as the minimum reserved traffic rate and the maximum sustained traffic rate. As is also fully familiar to those of ordinary skill in the art, an rtPS flow will not get admitted into the network if the requested minimum reserved bitrate cannot be guaranteed.)

Specifically, in accordance with one such illustrative embodiment of the present invention, the rtPS connection for the video stream comprising the I-frames may be advantageously assigned a higher minimum reserved bitrate parameter than is assigned to the rtPS connection for the video stream comprising the P-frames, which in turn may be advantageously assigned a higher minimum reserved bitrate parameter than is assigned to the rtPS connection for the video stream comprising the B-frames. This advantageously ensures that the video stream comprising the I-frames is transmitted across the communications network by a connection with sufficient resources to provide the highest protection against loss due to congestion. And similarly, the video stream comprising the P-frames has better protection than the video stream comprising the B-frames.

Note in particular that for typical MPEG encoded video signals, although B-frames generate the highest quantity of network traffic, they have the smallest impact on the resulting video quality of a reconstructed video signal (at the receiving end of a communications network), whereas I-frames, which generate the lowest quantity of network traffic, have the largest impact on the resulting video quality of a reconstructed video signal. This results from the fact that in order to sustain the highest video quality, it is crucial that the end user properly receives as many video frames as possible. To this end, it is most important to protect the more valuable frames (e.g., the I-frames) from being dropped (i.e., lost in transmission). Since, typically, all of the frames in a GOP are built from the base (i.e., first) frame, which is the I-frame, the loss of an I-frame will propagate throughout the GOP, and all of the other frames within that GOP will be corrupted. Similarly, the loss of a P-frame will likely adversely affect all subsequent P-frames and B-frames, as well as some preceding B-frames in the given GOP. On the other hand, the loss of B-frames will not typically propagate to any other frames and will therefore result in smaller quality degradations. As such, the approach described herein in accordance with this illustrative embodiment of the present invention advantageously provides preferential treatment for the frames that are more important for the preservation of video quality than others (since I-frames are more important than P-frames, which are in turn more important than B-frames).

In accordance with one illustrative embodiment of the present invention, a video server may advantageously indicate the encoding format used for each frame in the Type of Service (ToS) field of the Internet Protocol (IP) header. (IP headers and the ToS fields thereof are fully familiar to those of ordinary skill in the art.) In this manner, a base station (BS) can advantageously distinguish the frame type of each packet. Then, in accordance with an illustrative embodiment of the present invention, the MPEG encoded video frames are advantageously decomposed (at the BS) into three separate and independent video streams having three different rtPS flows with different minimum reserved bandwidth parameters. The parameters of each traffic flow (i.e., video stream) may, for example, be determined by the subscriber station (SS), or, alternatively, by the video server, and such parameters, when determined, may be advantageously sent to the BS during, for example, the call admission control process. As such, each of the three video streams is advantageously projected into three separate and independent traffic flows for (wireless) transmission to the SS.

As is fully familiar to those of ordinary skill in the art, when a traffic flow of a streaming video application is admitted in a WiMAX network, it has a corresponding downlink (DL) queue in the BS. Thus, the DL traffic from the video server to a WiMAX SS is enqueued at its corresponding DL queue in the BS. If the traffic flow is admitted as an rtPS flow, the BS has to guarantee the requested minimum reserved bitrate for the flow. The DL queue will overflow if the input traffic rate exceeds the guaranteed reserved bitrate and the BS is not able to allocate more resources to that flow due to either congestion or a lack of bandwidth availability. In any case, the waiting time in the queues will impose some delay to the traffic flow. Full queues will drop the incoming traffic and this will degrade the video quality. On the other hand, requesting a higher bitrate for a given flow will decrease its chance of admittance in the network. Hence, increasing the minimum reserved bitrate will force the BS to admit a smaller number of flows in the network, and this will decrease the overall network utility. Thus, there is a trade-off between video quality and network utility, which may, in accordance with an illustrative embodiment of the present invention, be advantageously optimized by choosing the optimum minimum reserved bitrate value for each video stream to be transmitted. As explained above, however, I-frames, P-frames and B-frames typically require different bitrates and there are significantly different numbers of such frame types in a given encoded video signal. Also as explained above, in accordance with certain illustrative embodiments of the present invention, video streams comprising B-frames require the largest bandwidth while they have the least effect on the video quality of the resultant reconstructed video signal (at the receiver).

Therefore, in accordance with certain illustrative embodiments of the present invention in which an encoded video signal is decomposed into three separate and independent video streams comprising I-frames, P-frames and B-frames, respectively (as shown, for example, in FIG. 2 and described above) and transmitted across a WiMAX communications network, a higher minimum reserved bitrate is advantageously allocated to the rtPS flow (i.e., the video stream) which comprises the I-frames than to the other two rtPS flows. Specifically, in accordance with certain ones of these illustrative embodiments, the probability of dropping I-frames is advantageously minimized by (conservatively) requesting a bitrate that is higher than the average bitrate of I-frames. Moreover, in accordance with an illustrative embodiment of the present invention, if the I-frame traffic flow does not consume all of the bandwidth allocated thereto, the BS advantageously provides the remaining portion of the allocated bandwidth to other traffic flows. In addition, in accordance with certain ones of these illustrative embodiments of the present invention, a minimum video quality is advantageously maintained by also requesting a minimum reserved bitrate for each of the rtPS flows (i.e., the video streams) which comprises the P-frames and the B-frames, respectively. In accordance with one such illustrative embodiment, the requested bitrates for these flows are advantageously less than the average bitrates of the corresponding flows (which will advantageously compensate for the fact that the requested bitrate for the rtPS flow comprising the I-frames may have been higher than the average bitrate of I-frames). Moreover, in accordance with certain ones of these illustrative embodiments of the present invention, a higher bitrate is requested for the rtPS flow comprising P-frames than is requested for the rtPS flow comprising B-frames, thereby advantageously reducing the probability that P-frames will be dropped as compared to the probability of dropping B-frames.

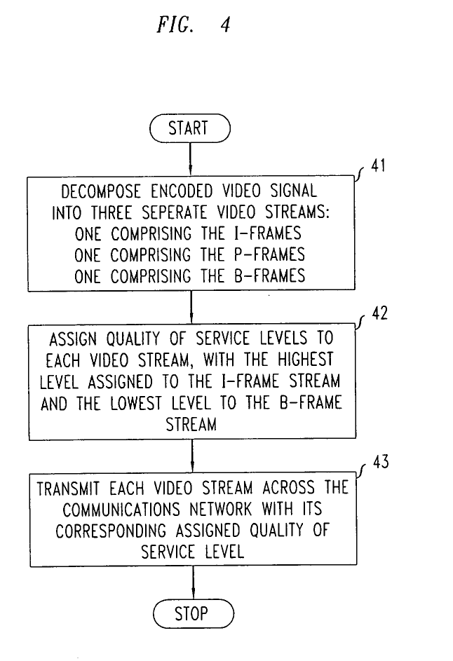

FIG. 4 shows a flowchart of a method of transmitting an encoded video signal across a communications network in accordance with an illustrative embodiment of the present invention. The illustrative method shown in the figure may, for example, be performed by a base station comprised in a WiMAX communications network. First, in block 41, the illustrative method of FIG. 4 takes the encoded video signal to be transmitted (which may, for example, have been received from a video server), and advantageously decomposes it into three separate video streams: one comprising all of the I-frames from the encoded video signal; one comprising all of the P-frames from the encoded video signal; and one comprising all of the B-frames from the encoded video signal. Then, in block 42, the illustrative method of FIG. 4 assigns (different) Quality of Service (QoS) levels to each of these three video streams such that the video stream comprising the I-frames has the highest QoS level assigned thereto and the video stream comprising the B-frames has the lowest QoS level assigned thereto (with the video stream comprising the P-frames thereby having a QoS level between the other two QoS levels). Finally, in block 43, the three video streams are independently and separately transmitted across the communications network (to their intended destination) with their corresponding QoS levels having been assigned thereto.

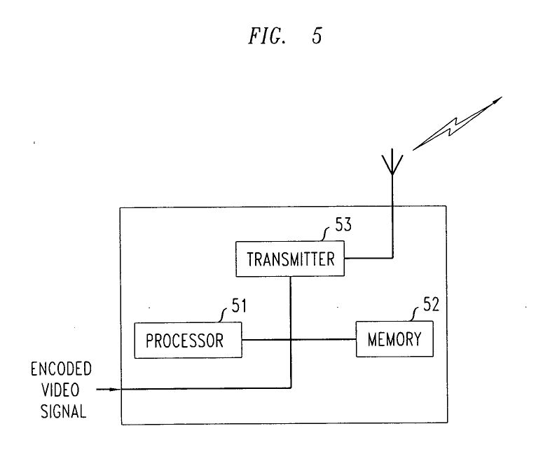

FIG. 5 shows a block diagram of an apparatus for transmitting an encoded video signal across a communications network in accordance with an illustrative embodiment of the present invention. The illustrative apparatus, which may, for example, be included within a base station comprised in a WiMAX communications network, comprises processor 51, memory 52, and transmitter 53. In operation, the encoded video signal (which may, for example, have been received from a video server) is advantageously decomposed into a plurality of separate and independent video streams, and transmitter 53 independently transmits each of these video streams across the communications network using, for example, transmitting antenna 54.

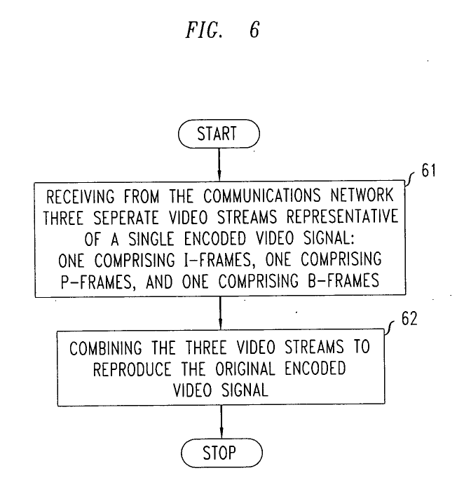

FIG. 6 shows a flowchart of a method of receiving an encoded video signal from a communications network in accordance with an illustrative embodiment of the present invention. The illustrative method shown in the figure may, for example, be performed by a subscriber station connected to a WiMAX communications network. First, in block 61, the illustrative method of FIG. 6 receives three separate and independent video streams from the communications network, each of which is (partially) representative of the (original) encoded video signal. In particular, one of the received video streams comprises I-frames from the (original) encoded video signal; one of the received video streams comprises P-frames from the (original) encoded video signal; and one of the received video streams comprises B-frames from the (original) encoded video signal. Then, in block 62, the illustrative method of FIG. 6 combines the three received video streams to reproduce the original encoded video signal. The resultant encoded video signal may, for example, be used by the subscriber station to display video content. (Typically, a video decoder will be employed at the subscriber station to decode the reproduced encoded video signal and to thereby produce a video signal which may be directly displayed at the subscriber station.)

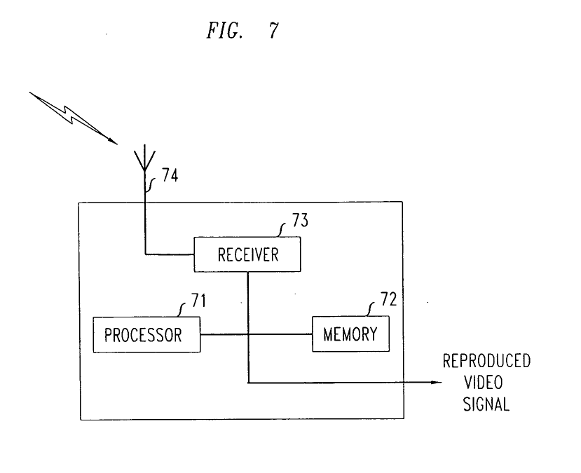

FIG. 7 shows a block diagram of an apparatus for receiving an encoded video signal from a communications network in accordance with an illustrative embodiment of the present invention. The illustrative apparatus, which may, for example, be included within a subscriber station connected to a WiMAX communications network, comprises processor 71, memory 72, and receiver 73. In operation, receiver 73 receives a plurality of separate and independent video streams from the communications network, using, for example, receiving antenna 74, and processor 71 combines the separate and independent video streams to reproduce the original encoded video signal. The resultant encoded video signal may, for example, be used by the subscriber station to display video content.

### Addendum to the Detailed Description

The preceding merely illustrates the principles of the invention. It will thus be appreciated that those skilled in the art will be able to devise various arrangements which, although not explicitly described or shown herein, embody the principles of the invention and are included within its spirit and scope. For example, although the above-described illustrative embodiments of the present invention have been described in the context of WiMAX and LTE networks, it will be obvious to one of ordinary skill in the art that the principles of the present invention may be applied in the context of other wireless, as well as wired, communications networks. In addition, although the above-described illustrative embodiments of the present invention have been described in the context of MPEG encoded video signals, it will be obvious to one of ordinary skill in the art that the principles of the present invention may be applied in the context of other video encoding techniques which encode individual frames of the video signal using two or more different encoding formats.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

A person of ordinary skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as magnetic disks and magnetic tapes, hard drives, or optically readable digital data storage media. The embodiments are also intended to cover computers programmed to perform said steps of the above-described methods.

The functions of any elements shown in the figures, including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

What is claimed is:

1. A method of transmitting an encoded video signal across a communications network, the encoded video signal comprising a plurality of encoded video frames, each encoded video frame having been encoded in one of two or more different encoding formats, the method comprising the steps of:
decomposing, with use of a processor, the encoded video signal into two or more video streams, each video stream comprising frames which have been encoded in one or more mutually exclusive formats with respect to each of the other video streams; and
independently transmitting, with use of a transmitter, each of the two or more video streams across the communications network as separate and independent flows.

2. The method of claim 1 wherein the encoded video signal has been encoded in accordance with a Motion Pictures Expert Group (MPEG) encoding technique, and wherein the encoding formats include Intra-coded frames (I-frames), forward Predictive frames (P-frames) and Bi-directionally predicted frames (B-frames).

3. The method of claim 2 wherein the encoded video signal is decomposed into three video streams, the three video streams including a first video stream comprising exclusively I-frames, a second video stream comprising exclusively P-frames, and a third video stream comprising exclusively B-frames.

4. The method of claim 1 wherein each of the independently transmitted video streams is transmitted with a different Quality of Service (QoS) level.

5. The method of claim 4 wherein the QoS level of each transmitted video stream is based on a corresponding QoS set of parameters representative of a minimum reserved bandwidth which is to be associated therewith.

6. The method of claim 5 wherein the video streams are being transmitted to one or more subscriber stations, the method further comprising the step of receiving QoS parameter values to be used to specify the QoS levels of each of said video streams from at least one of said subscriber stations.

7. The method of claim 5 wherein the encoded video signal is provided by a video server, the method further comprising the step of receiving QoS parameter values to be used to specify the QoS levels of each of said video streams from the video server.

8. The method of claim 1 wherein the communications network comprises one of a WiMAX network or an LTE network.

9. A method of receiving an encoded video signal from a communications network, the encoded video signal comprising a plurality of encoded video frames, each encoded video frame having been encoded in one of two or more different encoding formats, the method comprising the steps of:
receiving, with use of a receiver, two or more independently transmitted video streams as separate and independent flows, each video stream comprising frames which have been encoded in one or more mutually exclusive formats with respect to each of the other video streams; and
combining, with use of a processor, the received video frames to reproduce the encoded video signal.

10. The method of claim 9 wherein the encoded video signal has been encoded in accordance with a Motion Pictures Expert Group (MPEG) encoding technique, and wherein the encoding formats include Intra-coded frames (I-frames), forward Predictive frames (P-frames) and Bi-directionally predicted frames (B-frames).

11. The method of claim 10 wherein three independently transmitted video streams are received, the three video streams including a first video stream comprising exclusively I-frames, a second video stream comprising exclusively P-frames, and a third video stream comprising exclusively B-frames.

12. The method of claim 9 wherein each of the independently transmitted video streams has been transmitted with a different Quality of Service (QoS) level.

13. The method of claim 12 wherein the QoS level of each transmitted video stream was based on a corresponding QoS set of parameters representative of a minimum reserved bandwidth which had been associated therewith.

14. The method of claim 9 wherein the communications network comprises one of a WiMAX network or an LTE network.

15. The method of claim 9 wherein one or more of the frames comprised in one or more of the encoded video streams has been lost in transmission across the communications network.

16. An apparatus for transmitting an encoded video signal across a communications network, the encoded video signal comprising a plurality of encoded video frames, each encoded video frame having been encoded in one of two or more different encoding formats, the apparatus comprising:
a processor which decomposes the encoded video signal into two or more video streams, each video stream comprising frames which have been encoded in one or more mutually exclusive formats with respect to each of the other video streams; and
a transmitter which independently transmits each of the two or more video streams across the communications network as separate and independent flows.

17. The apparatus of claim 16 wherein the encoded video signal has been encoded in accordance with a Motion Pictures Expert Group (MPEG) encoding technique, and wherein the encoding formats include Intra-coded frames (I-frames), forward Predictive frames (P-frames) and Bi-directionally predicted frames (B-frames).

18. The apparatus of claim 17 wherein the encoded video signal is decomposed into three video streams, the three video streams including a first video stream comprising exclusively I-frames, a second video stream comprising exclusively P-frames, and a third video stream comprising exclusively B-frames.

19. The apparatus of claim 16 wherein each of the independently transmitted video streams is transmitted with a different Quality of Service (QoS) level.

20. The apparatus of claim 19 wherein the QoS level of each transmitted video stream is based on a corresponding QoS set of parameters representative of a minimum reserved bandwidth which is to be associated therewith.

21. The apparatus of claim 20 wherein the video streams are being transmitted to one or more subscriber stations, the apparatus further comprising a receiver which receives QoS parameter values to be used to specify the QoS levels of each of said video streams from at least one of said subscriber stations.

22. The apparatus of claim 20 wherein the encoded video signal is provided by a video server, the method further comprising a receiver which receives QoS parameter values to be used to specify the QoS levels of each of said video streams from the video server.

23. The apparatus of claim 16 wherein the communications network comprises one of a WiMAX network or an LTE network.

24. An apparatus for receiving an encoded video signal from a communications network, the encoded video signal comprising a plurality of encoded video frames, each encoded video frame having been encoded in one of two or more different encoding formats, the apparatus comprising:
a receiver which receives two or more independently transmitted video streams as separate and independent flows, each video stream comprising frames which have been encoded in one or more mutually exclusive formats with respect to each of the other video streams; and
a processor which combines the received video frames to reproduce the encoded video signal.

25. The apparatus of claim 24 wherein the encoded video signal has been encoded in accordance with a Motion Pictures Expert Group (MPEG) encoding technique, and wherein the encoding formats include Intra-coded frames (I-frames), forward Predictive frames (P-frames) and Bi-directionally predicted frames (B-frames).

26. The apparatus of claim 25 wherein three independently transmitted video streams are received, the three video streams including a first video stream comprising exclusively I-frames, a second video stream comprising exclusively P-frames, and a third video stream comprising exclusively B-frames.

27. The apparatus of claim 24 wherein each of the independently transmitted video streams has been transmitted with a different Quality of Service (QoS) level.

28. The apparatus of claim 27 wherein the QoS level of each transmitted video stream was based on a corresponding QoS set of parameters representative of a minimum reserved bandwidth which had been associated therewith.

29. The apparatus of claim 24 wherein the communications network comprises one of a WiMAX network or an LTE network.

30. The apparatus of claim 24 wherein one or more of the frames comprised in one or more of the encoded video streams has been lost in transmission across the communications network.
